(19) United States
(12) Patent Application Publication
(10) Pub. No.: US 2006/0164869 A1
(43) Pub. Date: Jul. 27, 2006

(54) Inverter

(75) Inventor: Takeshi Uematsu, Tokyo (JP)

Correspondence Address: OLIFF & BERRIDGE, PLC, P.O. BOX 19928, ALEXANDRIA, VA, 22320, US

(73) Assignee: TDK Corporation, Tokyo (JP)

(21) Appl. No.: 11/335,463

(22) Filed: Jan. 20, 2006

(30) Foreign Application Priority Data
Jan. 21, 2005 (JP) 2005-14373

(51) Int. Cl. H02M 3/335

(52) U.S. Cl. 363/16

(57) ABSTRACT

An inverter circuit has a switching element, an inductance, a transformer, a capacitor, and a controller. The switching element is connectable between a higher potential terminal and a lower potential terminal of a direct-current power supply. The inductance is connected between the higher potential terminal and the switching element. The transformer has a primary winding and a secondary winding. The secondary winding has two ends. The capacitor is connected to the primary winding in series. The series-connected capacitor and primary winding is connected in parallel to the switching element. The controller switches the switching element. Therefore, the inverter circuit converts a direct current supplied from the direct-current power supply to an alternating current. The number of switching element in the inverter circuit is only one so that the structure of the inverter circuit is simplified and the manufacturing cost thereof can be reduced.

### BACKGROUND OF THE INVENTION

1. Technical Field

The present invention relates to an inverter circuit that converts a direct current to an alternating current and outputs the converted alternating current. In particular, the present invention relates to an inverter circuit which is employed as a power supply circuit of various electronics devices including a backlight for a liquid crystal display.

2. Related Art

Japanese Patent Application Publication Hei 5-343190 discloses an inverter circuit including a pair of transistors as switching elements and a transformer. A direct current is supplied to a middle point of a transformer and respective bases of the transistors through a resistor. In the inverter circuit, the paired transistors are alternately switched with a resonance frequency which is determined by an inductance of the transformer and capacities of two capacitors. Accordingly, an alternating current having a predetermined frequency depending on the switching frequency is produced at output terminals of the transformer.

However, in above-described inverter circuit, two transistors are used as switching elements. Generally, at least two switching elements are necessary to manufacture an inverter circuit such as the above-described inverter circuit. Thus, reduction of the number of parts, downsizing of the circuit configuration, and reduction of cost are problems to be solved.

An object of the present invention is to provide an inverter circuit in which the number of parts is reduced, thereby enabling miniaturization and cost reduction of the inverter circuit.

### SUMMARY OF THE INVENTION

The present invention provides an inverter circuit for converting a direct current to an alternating current, having: a switching element, an inductance, a transformer, a first capacitor, and a controller. The switching element is connectable between a higher potential terminal and a lower potential terminal of a direct-current power supply. The inductance is connected between the higher potential and the switching element. The transformer has a primary winding and a secondary winding. The secondary winding has two ends. The first capacitor is connected to the primary winding in series. The series-connected first capacitor and primary winding is connected in parallel to the switching element. The controller switches the switching element. Therefore, the inverter circuit converts a direct current supplied from the direct-current power supply to an alternating current.

### BRIEF DESCRIPTION OF THE DRAWINGS

The aforementioned aspects and other features of the invention are explained in the following description, taken in connection with the accompanying drawing figures wherein:

FIG. 1 is a circuit diagram indicative of the configuration of an inverter circuit of an embodiment according to the present invention;

FIG. 2A is a wave chart showing a gate signal for a switching element S1;

FIG. 2B is a wave chart showing a voltage of a primary winding L1 in a transformer; and

FIG. 3 is a wave chart indicative of an example of an alternating voltage produced from the inverter circuit.

### DESCRIPTION OF THE EMBODIMENT

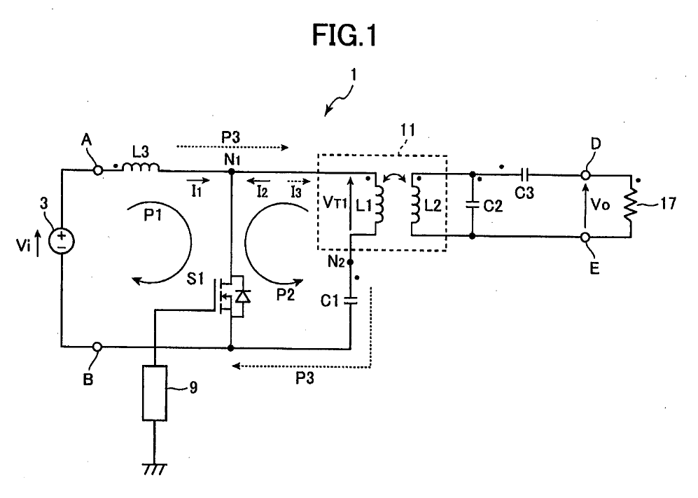

An embodiment according to the present invention will be described below with reference to FIGS. 1-3.

Referring to FIG. 1, an inverter circuit 1 according to the present invention includes a direct-current power supply 3, an inductor L3, a switching element S1, a capacitor C1, a transformer 11, capacitors C2, C3, and a controller 9.

The direct-current power supply 3 is a power supply that produces a direct-current voltage having a predetermined value V1. The direct-current power supply 3 has terminals A, B to output the direct-current voltage. The terminal A has a higher potential than the terminal B. The terminal B is connected to a reference potential G1. A direct current of a predetermined current value flows from the direct-current power supply 3 through the terminals A, B. Alternatively, the direct-current power supply 3 may be configured by a commercial alternating-current power supply and a rectifying circuit to produce a direct-current flow.

An inductor L3 is electrically connected between the input terminal A and a node N1. A switching element S1 is connected between the node N1 and the input terminal B. The inductor L3 accumulates electric energy supplied from the direct-current power supply 3 as magnetic energy. Accordingly, the inductor L3 has a function as a booster. In this embodiment, the switching element S1 is made from a field-effect transistor (FET). The switching element S1 has a gate terminal connected to the control circuit 9, thereby performing a switching operation in response to a gate signal G1 supplied from the control circuit 9.

The transformer 11 includes a primary winding L1 and a secondary winding L2 with their transformation ratio of 1 to “n”. The primary winding L1 and the secondary winding L2 are arranged in the transformer 11 to exhibit homopolarity to each other.

The primary winding L1 and the capacitor C1 are connected in series. The series-connected primary winding and capacitor C1 are connected to the switching element S1 in parallel. Due to an electromagnetic induction between the primary winding L1 and the secondary winding L2, the secondary winding L2 produces an electromotive force depending on the transformer ratio.

The capacitor C2 is connected to the secondary winding L2 in parallel. The capacitor C2 smoothes the output from the secondary winding L2. The capacitor C3 is connected between the output terminals D and one end of the capacitor C2. The capacitor C3 cuts off the direct-current component of the output of the secondary winding L2. An impedance load 17 such as a cold-cathode tube is connectable to the output terminals D, E.

The operation of the inverter circuit 1 will be described. As shown in FIG. 1, the direct-current power supply 3 applies a direct-current voltage V1 between the input terminals A, B. The switching element S1 is controlled by the control circuit 9 to perform the switching operation in response to the gate signal G1.

When the switching element S1 is on in response to a higher level of the gate signal G1, the direct-current power supply 3, the inductor L3, and the switching element S1 form a close electric path P1. Accordingly, a direct current I1 flows from the direct-current power supply 3 through the inductor L3, and the switching element S1 in turn. Simultaneously, the switching element S1, the capacitor C1, and the primary winding L1 forms another close electric path P2 so that another direct current I2 flows in the close electric path P2. The direct current I2 passes through the primary winding L1 in a direction from the node N2 to the node N1.

When the switching element S1 is off in response to a lower level of the gate signal G1, the direct-current power supply 3, the primary winding L1, and the capacitor C1 form a close electric path P3 so that a direct current I3 passes through from the direct-current power supply 3 through the inductor L3, the primary winding L1, and the capacitor C1 in turn. Further, the magnetic energy accumulated in the inductor L3 is added to the direct current voltage Vi from the direct-current power supply 3. At this time, the direct current I3 passes through the primary winding L1 in a direction from the node N1 to the node N2.

As described above, the direction of the current flow that flows through the primary winding L1 is periodically reversed in response to the switching of the switching element S1,.

The secondary winding L2 is subject to an electromagnetic induction by the primary winding L1 to induce an electromotive force depending on the transformer ratio. The electromotive force induced by the secondary winding L2 has a polarity depending on the direction of the current flow passing through the primary winding L1, thereby generating an alternating current flow. The capacitor C2 smoothes the output current flow of the secondary winding L2. The capacitor C3 cuts off the direct-current component of the output of the secondary winding L2. Accordingly, an alternating voltage Vₒ appears between the output terminals D, E.

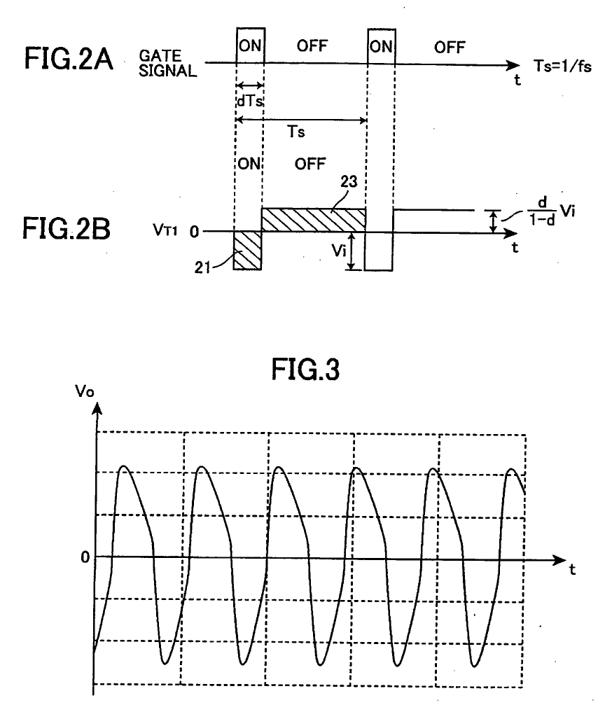

FIGS. 2A and 2B shows a time-chart indicative of the relation between a voltage V_{T1} of the primary winding L1 of the transformer 11 and the gate signal G1 supplied to the switching element S1. The switching element S1 repeats the switching operation in a cycle of Ts. When the duty of the switching operation of the switching elemental is set to be “d” in the cycle Ts, the switching element S1 is on during a time period of dTs, and off during a time period other than the time period dTs, i.e., (1−d)Ts.

The capacitor generally has a function of cutting off a direct-current component. Accordingly, when the switching element S1 is on, the voltage of the capacitor C1 is equivalent to the direct-current voltage Vi. Therefore, when the polarity of the voltage V_{T1} is defined so that the lower potential node N2 is set to a reference potential, the voltage V_{T1} of the primary winding L1 becomes −Vᵢ, as shown in FIG. 2A.

On the other hand, the electric energy accumulated in the capacitor C1 must be equal to discharged energy in the capacitor C1 when the switching element S1 is off according to the conservation of energy. Therefore, an area 21 during the charging period of the capacitor C1 is equal to an area 23 during the discharging period, as shown in FIG. 2B. As a result, the voltage V_{T1} becomes Vᵢ·{d/(1−d)} when the switching element S1 is off.

Based on the above description, when the value of d is equal to 0.5, the voltage value V_{T1} during the time period in which the switching element S1 is on is equal to the voltage value V_{T1} during with that during the time period in which the switching element S1 is off. At this time, an ideal resonance happens in the close circuit P1 including the primary winding L1 and the capacitor C1. In this case, it should be noted that energy loss generated by wires is ignored.

In this embodiment, the cycle Ts is an inverse number of “fs” that is a resonance frequency of a circuit including the secondary winding L2, that is, 1/fs. The resonance frequency “fs” is defined as fs=½π(LC2)^{1/2}, where L is an inductance of a circuit including the secondary winding L2, and C2 is a capacitance of the capacitor C2.

FIG. 3 shows a wave chart indicative of an example the output voltage Vₒ appearing between the output terminals D, E. When the inverter circuit 1 is configured as shown in FIG. 1, and the cycle Ts and the duty “d” of the switching operation of the switching element S1 are selected in a proper manner, the voltage Vₒ appearing between the output terminals D, E becomes an alternating voltage shown in FIG. 3. In other words, the inverter circuit 1 is able to convert a direct current flow from the direct-current power supply 3 to an alternating current flow to output the converted alternating current.

As described above, the inverter circuit 1 of the present embodiment produces an alternating current flow having a predetermined frequency from the output terminals D, E by selecting the cycle Ts and the duty “d” of the switching operation of the switching element S1. The cycle Ts can be adjusted to a desired cycle value by changing the capacitance of the capacitor C2. If energy loss generated by wires in the inverter circuit 1 is ignored, the switching frequency of the switching element S1 is selected to be the resonance frequency of the circuit including the secondary winding L2, and the duty is set to be 50%. In this case, the inverter circuit 1 is able to perform an ideal resonance.

Furthermore, since the inverter circuit 1 including only one switching element S1 produces an alternating current, the number of parts in the inverter circuit 1 can be reduced and the circuit configuration can be simplified as compared with other types of inverter circuits such as a full bridge type and a half-bridge type. Further, a manufacturing cost of the inverter circuit 1 can be reduced.

As described above, the inverter circuit having only one switching element can be configured. Since this inverter circuit produces an alternating current using only one switching element, the total number of parts of the inverter circuit is reduced, and downsizing and cost reduction are realized.

According to the present invention, a small-sized and low-cost inverter circuit with its number of parts reduced and circuit configuration simplified can be provided.

The inverter circuit of the present invention is not limited to above-described configuration, and various modifications and alternative constructions can be implemented without departing from the scope and spirit of the present invention. Other circuit configurations are not restricted to those described above, and other elements may be employed as long as similar operations and performances can be obtained.

The ideal duty of the switching operation of the switching element S1 is not necessarily 0.5, and may be changed depending on the circuit characteristics. Accordingly, it is preferable to adjust the duty of the switching operation, depending on characteristics of respective circuits.

In another embodiment, the capacitor C1 can be positioned on a higher potential side than the primary winding L1 of the transformer 11. In this case, the same effects and advantages can be obtained as those of the first embodiment.

What is claimed is:

1. An inverter circuit comprising:
a switching element connectable between a higher potential terminal and a lower potential terminal of a direct-current power supply;
an inductance connected between the higher potential terminal and the switching element;
a transformer comprising a primary winding and a secondary winding, the secondary winding having two ends;
a first capacitor connected to the primary winding in series, the series-connected first capacitor and primary winding being connected in parallel to the switching element; and
a controller for switching the switching element, thereby converting a direct current supplied from the direct-current power supply to an alternating current.

2. The inverter circuit according to claim 1, further comprising:
a second capacitor connected in parallel to the secondary winding;
a pair of output terminals connected to the ends of the secondary winding, respectively; and
a third capacitor connected between one of the pair of output terminals and one of the two ends of the secondary winding, wherein the alternating current is generated between the pair of output terminals.
